(19) United States
(12) Patent Application Publication
(10) Pub. No.: US 2015/0070131 A1
(43) Pub. Date: Mar. 12, 2015

(54) METHOD AND APPARATUS FOR DETECTING BOARDING OF A MEANS OF TRANSPORT

(71) Applicant: HERE Global B.V., Veldhoven (NL)

(72) Inventors: Jerome BEAUREPAIRE, Berlin (DE); Marko Tapio TUUKKANEN, Schlenzer (DE)

(73) Assignee: HERE Global B.V., Veldhoven (NL)

(21) Appl. No.: 14/024,134

(22) Filed: Sep. 11, 2013

(51) Int. Cl. H04W 4/04; G07C 9/00

(52) U.S. Cl. CPC H04W 4/04; G07C 9/00134
USPC 340/5.8

(57) ABSTRACT

An approach is provided for detecting when a user has boarded a means of transport. The sensor platform may determine sensor information associated with at least one device, wherein the sensor information is collected from one or more sensors that do not include one or more satellite-based location sensors. Then, the sensor platform may process and/or facilitate a processing of the sensor information to determine at least one entry or at least one exit of the at least one device with respect to at least one structure, at least one supporting structure associated with the at least one structure, or a combination thereof associated with one or more transport means.

### BACKGROUND

Service providers and device manufacturers (e.g., wireless, cellular, etc.) are continually challenged to deliver value and convenience to consumers by, for example, providing compelling network services. One area of interest has been the development of offering notifications or navigational options tailored to a user's contextual information. For example, commuters boarding a train or city subway system may have to transfer rail lines. Navigational tools exist to direct users to train stations and real-time train schedules exist where users may check to see when trains are arriving at various stations. However, location detection by Global Positioning System (GPS), for example, is often unavailable especially in underground train systems. This means that information involving transfers is often unavailable when a user is underground, riding a train. Therefore, recommendations for transferring stations may be generated prior to a user boarding a train, but the recommendations may not be automatically updated once a user has boarded a train. Therefore, content providers face challenges in offering users real-time, relevant guidance in facilitating transportation transfers.

### SOME EXAMPLE EMBODIMENTS

Therefore, there is a need for an approach for detecting when a user has boarded a means of transport.

According to one embodiment, a method comprises determining sensor information associated with at least one device, wherein the sensor information is collected from one or more sensors that do not include one or more satellite-based location sensors. The method also comprises processing and/or facilitating a processing of the sensor information to determine at least one entry or at least one exit of the at least one device with respect to at least one structure, at least one supporting structure associated with the at least one structure, or a combination thereof associated with one or more transport means.

According to another embodiment, an apparatus comprises at least one processor, and at least one memory including computer program code for one or more computer programs, the at least one memory and the computer program code configured to, with the at least one processor, cause, at least in part, the apparatus to determine sensor information associated with at least one device, wherein the sensor information is collected from one or more sensors that do not include one or more satellite-based location sensors. The apparatus is also caused to process and/or facilitate a processing of the sensor information to determine at least one entry or at least one exit of the at least one device with respect to at least one structure, at least one supporting structure associated with the at least one structure, or a combination thereof associated with one or more transport means.

According to another embodiment, a computer-readable storage medium carries one or more sequences of one or more instructions which, when executed by one or more processors, cause, at least in part, an apparatus to determine sensor information associated with at least one device, wherein the sensor information is collected from one or more sensors that do not include one or more satellite-based location sensors. The apparatus is also caused to process and/or facilitate a processing of the sensor information to determine at least one entry or at least one exit of the at least one device with respect to at least one structure, at least one supporting structure associated with the at least one structure, or a combination thereof associated with one or more transport means.

According to another embodiment, an apparatus comprises means for determining sensor information associated with at least one device, wherein the sensor information is collected from one or more sensors that do not include one or more satellite-based location sensors. The apparatus also comprises means for processing and/or facilitating a processing of the sensor information to determine at least one entry or at least one exit of the at least one device with respect to at least one structure, at least one supporting structure associated with the at least one structure, or a combination thereof associated with one or more transport means.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting when a user has boarded a means of transport, according to one embodiment;

FIG. 2A is a diagram of the components of a sensor platform, according to one embodiment;

FIG. 2B is a diagram of the components of a transport platform, according to one embodiment;

FIG. 3 is a flowchart of a process for detecting when a user has boarded a means of transport, according to one embodiment;

FIG. 4 is a flowchart of a process for determining the location of a user or device associated with a user relative to a transport means, according to one embodiment;

FIG. 5 is a flowchart of a process for determining the progress of a user or device associated with a user relative to a transport means, according to one embodiment;

FIG. 6 is a flowchart of a process for determining whether to initiate the determination of sensor information, according to one embodiment;

FIG. 7 is a diagram of a use case, according to one embodiment;

FIGS. 8A and 8B are diagrams of two phases of a use case with system 100, according to one embodiment;

FIG. 9 is a diagram of user interfaces utilized in the processes of FIG. 3, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for detecting when a user has boarded a means of transport are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

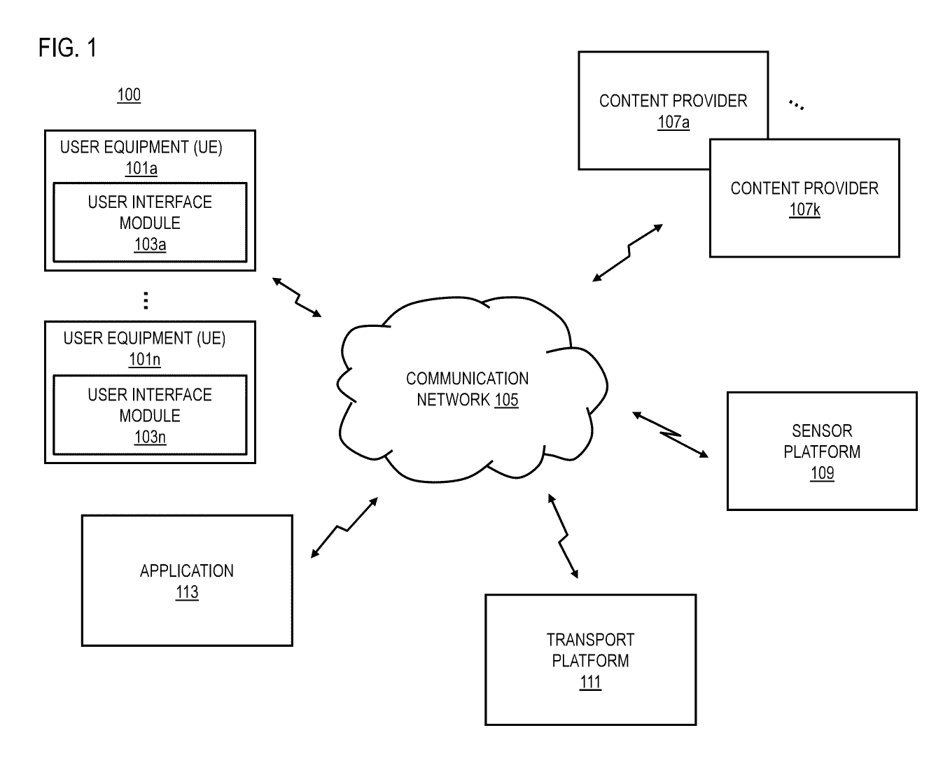

FIG. 1 is a diagram of a system capable of detecting when a user has boarded a means of transport, according to one embodiment. Service providers and device manufacturers (e.g., wireless, cellular, etc.) are continually challenged to deliver value and convenience to consumers. One area of interest includes services that offer navigational aid. Existing public transport and navigation applications can often lead users to locations to receive transport. For example, navigation applications may map and show users routes to bus stops, train stations, subway stations, etc. In addition users may access, for example, public transportation time tables that may inform them of arriving transportation means. For instance, a user at a train station may access an application informing him of the next train arriving at that station or platform. However, the applications do not automatically follow a user's travel during a commute. For example, the applications do not update train schedule information relative to a user's route unless the user manually selects to view a train line or station. Therefore, content providers face challenges in determining the most relevant commute to recommend to a user.

To address this problem, a system 100 of FIG. 1 introduces the capability to detect when a user has boarded a means of transport, according to one embodiment. For example, a means of transport may include the systems associated with trains, underground trains, subways, railways, buses, rail-to-bus combinations, trolleys, trams, various forms of public transport, elevators, or a combination thereof. The transport means may include public transport means, for instance, and especially transport means with pre-set or known schedules. For instance, trains run along known schedules. A given train is expected at a set of stations, each at a given time in a day. A train system is then one example of a transport means. In one embodiment, a means of transport may further be associated with one or more structures and/or one or more supporting structures. The actual objects in motion may be one of the structures, for instance, buses, railways, subways, trolleys, trams, individual rail cars and/or entire trains. Other examples of structures may include elevators, escalators, and moving sidewalks. The supporting structures may include the structures constructing a network where these structures are expected to travel. For example, train stations, bus stops, trolley stops, floors for an elevator, may all serve as supporting structures. Entry or exit of a device may include, for example, a user possessing a device, boarding and exiting of a train.

In one embodiment, the system 100 may initiate when satellite-based location sensors are unavailable. Satellite-based location sensors may include GPS location sensors, which may directly determine a user's location. However, GPS location sensors, for instance, are often unavailable in underground subway tunnels. In addition, various platforms may be at the same location, but at different levels. Then, a system 100 may be unable to detect exactly which subway, rail, or platform a user may be using, despite knowing the user's GPS coordinates. Therefore, system 100 may rely on non-satellite-based location sensors to determine when a user has boarded or exited a transport means in order to give a user the most relevant transport means arrival times at various pre-determined stops along a user's route. Essentially, the system 100 may employ means other than GPS location sensors to determine a user's location and movement along the pre-set routes of public transportation. In one embodiment, the system 100 may employ dead reckoning, where a last known GPS location is integrated with information from non-satellite-based sensors. For example, a GPS location may provide a last-known user location while sensors providing sensory information help to determine a user's position while the user is indoors or underground.

The sensors that provide sensory information may include, for example, magnetometers, acceleration sensors, motion sensors, altitude sensors, light sensors, and noise sensors. In one embodiment, these sensors may be non-satellite-based sensors. For example, since transport means are often made out of metal, magnetometers may determine whether a user is outside a transport means or inside a transport means. For instance, if a magnetometer suddenly detects a high presence of metal proximate a user, it is likely that a user is inside a transport means. For example, the user may be inside a rail car or bus. (The user has boarded the rail car or bus.) If, however, a magnetometer does not detect a high presence of metal proximate a user, a user might be outside a rail car and/or rail station. (The user may have exited a rail car or have yet to board a rail car.) In one scenario, the system 100 focuses on changes in sensor readings. For example, a user working in an area with a lot of skyscrapers may perpetually have magnetometer readings associated with the user as detecting metal. Then, detecting metal near this user may not signify that a user is employing a transport means. The user may simply be walking alongside skyscrapers. The system 100 may look to changes in magnetometer readings to determine if a user's method of transportation is actually in flux or whether contextual factors are contributing to the sensor readings. In another scenario, the readings may be associated with timing. For example, trains in a certain public transportation system may stop at a platform for 30 seconds. In this public transportation system, is a user's magnetometer detects greater amounts of metal for less than 30 seconds, it is unlikely that a user is actually on aboard a train. Instead, the user may simply be standing on a platform and trains stopping at the platform contribute to the magnetometer readings. If, however, the magnetometer detects metal for more than 30 seconds, the system 100 may understand this to mean that a user is likely on board a train. Likewise, when the magnetometer reading changes again, the system 100 may conclude that a user has exited a train.

In an additional embodiment, system 100 may note perturbations in magnetometer readings. For example, the perturbations may be due to changes in magnetic fields caused by electric motors used in trains. The detected perturbations may permit system 100 to draw conclusions about if and when a user boards a train (or an elevator, etc.). The changes in magnetic fields identified by the perturbations may also indicate that a train is moving. In a further embodiment, the system 100 may further detect a direction of a movement if the magnet if field pattern is dissimilar in different directions, i.e. comparing a current pattern to stored patterns. In one scenario, an electronic compass is one type of a magnetometer.

Acceleration sensors may determine a direction of movement (associated with a device). For instance, the acceleration sensors may determine that a user is being conveyed along a route via a transport means since there is a sudden acceleration associated with a user. For instance, if a pedestrian enters a tram, acceleration sensors would determine a sudden acceleration. System 100 may then note that a user is likely now aboard a transport means and determine the direction of movement and/or acceleration. In one embodiment, acceleration sensor data may be compared against a set of information indicating, for instance, the side of a platform that a train will be on. For example at a given platform, an eastbound train may arrive on the left side whereas a westbound train may arrive on the right side of the platform. Then, system 100 may determine that a user is riding east if she enters a train on the left side and that she is riding west if she boards on the left side. A further method of determining direction may include comparing a user's destination information with destination information associated with other users in the same transport means. For example, if a user is heading for station A at the far northern side of a line whereas everyone else is heading south towards a station F, the system 100 may determine that the user may be riding in the wrong direction for his destination of station A. In one embodiment, the system 100 may provide a notification warning the user of the possible error. In one embodiment, the system 100 may also include a recommendation for where and when to transfer in order to best correct the journey.

In one embodiment, motion sensors and acceleration sensors may include motion sensor algorithms that detect whether an associated device is stationary. For example, a device with a motion sensor may sense the difference in its own position, for instance, “stationary” or “in palm.” In addition, the motion sensor may identify movement of a user associated with the device. For instance, a motion sensor may sense whether a user associated with a device is walking, running, driving, etc. For instance, if the device is in the hand of the user, the motion sensor may process received sensor information with various algorithms to deduce a pattern of movement that a user is adhering to. In addition, a change in an identified pattern of movement may further indicate that a user is boarding a train. For instance, a change from “in palm” to “walking” may correlate to a user going from a standing position (on a train platform), to walking a few steps to find a seat on a train.

In one embodiment, motion sensors or altitude sensors may be incorporated with various positions of the user. For example, system 100 may incorporate a wrist device with sensors. In one scenario, the wrist sensor may convey information about a user's body positions that may further indicate whether he has boarded a train. For instance, a user holding his hand over his head or higher for a pre-set period of time may cause the system 100 to infer that a user is holding onto something in the train. This may provide a further piece of input as to whether a user has boarded a train.

In one embodiment, altitude sensors may be used to detect the platform or station from which a user has boarded (or exited) a train. Altitude sensors may provide another means of finding the positioning of a user while the user is underground or while satellite-based sensors are unavailable. For instance, train stations may have platforms at various levels and train stations may be situated at different levels. Furthermore, various subway and train stations may also be at different altitudes. An altitude may be an identifying characteristic allowing the system 100 to identify a train station (supporting structure) where a user is located. By extension, in comparing the identified supporting structure, time, and known schedules, system 100 may identify a transport structure, for example, a train. For instance, the system 100 may identify that a user is in a blue line train, given the platform that a user has arrived at, at 12:30. The train schedules may indicate that at that particular platform at 12:30, a blue line train is scheduled to arrive. Perhaps a 12:40 arrival time at that platform would lead to the identification of a yellow line train, since the train schedule indicates yellow line train at this platform at 12:40, blue line train at 12:30.

In one embodiment, the same information may indicate when a user enters and exits a transport means. In one embodiment, the system 100 may further determine which transport means structure (and supporting structure) a user is entering or exiting. In one embodiment, this determination includes the previous discussion where the structure may be a train that is part of a scheduled train line, with a platform being a supporting structure. For instance, identifying a train structure may include determining that a user is, specifically, on a 2 pm commuter blue line train. In another embodiment, determining the transport means may further include distinguishing between various types of transport situated in close proximity. For example, the system 100 may use sensor information to determine whether a user is on a train in a station, or an elevator or escalator in the train station. For example, magnetometer readings may indicate that a user has entered a metal enclosure, but it may be unclear as to whether the enclosure is in a train, and elevator, or an escalator. An increase in altitude sensor readings may show that a user is on an elevator or escalator, whereas consistent altitude reading may allow the system 100 to conclude that a user is in a train. In addition, acceleration sensor readings with a horizontal component may indicate that a user is in a train or escalator, whereas readings that show direction of movement largely in the vertical plane may indicate to the system 100 that a user is in an elevator. In addition, the sensor information may further inform users of how to maximize timing or efficiency in their journey. For instance, entering in one car of a train may allow a user to be directly outside elevators when she exists, whereas entering another car in the same train would put the user very far from the elevators when she exits.

In a further embodiment, the system 100 may determine the position of a device relative to other devices in order to see which transport structures and supporting structures are associated with a user's entrance and exit. For instance, system 100 may detect not only a direction of movement, but a shape of the area where devices are. For example, train cars may be rectangles with dimensions of 15 meters by 3 meters. If a device detects that it is within a space that is a rectangular shape 15 meters long and 3 meters wide, system 100 may determine that a user is inside a train. Devices within a platform, however, might be more spread out. For example, there might be 25 meters between users. If a user has a radius of 25 meters around him with few other devices detected, he is likely not on a train. Likewise, bench seats in a train car might be approximated as rectangles 12 meters long and 0.3 meters wide (when the seats extend along a train car) whereas benches in a train station are benches, 2 meters long and 1 meter wide. Detection of one set of shapes over another may indicate whether a user is inside our outside of a train. In one scenario, system 100 may employ detection of new devices entering the range of a wireless transmitter. Aggregating information of density of devices with movement and altitude sensor data may permit system 100 to draw conclusions on whether a user is on a platform, in the middle of a station, surrounded by people on a platform, in a crowded train car, in an empty train car, etc.

In one embodiment, light or luminosity sensors may also indicate whether a user has boarded a train. For instance, detecting the presence or absence of light (or a difference between sunlight or artificial light) may indicate that a user is aboard a train, inside a station, or has reached a point in her journey where a train enters or exits and underground area or a tunnel. Noise detection from noise sensors may further provide boarding information. For example, noise detection may include determining a noise pattern for train arrivals and/or departures. For instance, doors opening and closing or public announcements may make up particular patterns of sound associated with arrivals and departures. For instance, noise sensors may detect and identify standard announcements. One such scenario may include detecting announcements including, “next stop” or “please do not lean on doors”, since this may indicate that a user is within a train. Announcements referring to supporting structures, for instance, “Platform 2, ICE to Berlin. Platform 4, ICE to Munich” or “Please stand back from the platform”, may mean that a user is outside a train or that a train is at a station. In one case, capturing and analyzing public announcements to determine whether a user is inside or outside of a train may include capturing announcements for people with hearing aids. One such scenario may include the system 100 capturing announcements from a radio channel associated with transit system announcements, similar to announcements sent over loudspeakers in trains and train stations. Also, noise sensor may pick up on differences in echo between sounds received while outside of a train and inside a train. Furthermore, Doppler effects may inform system 100. For example, a user (and associated device) standing still at a stop observing an approaching vehicle will receive sounds differently from a user in a moving device. This difference may also aid determination of whether a user has boarded a structure. In a further scenario, vehicle boarding may be detected if a user “checks in” or “taps in.” In one such case, a user may tap his phone to a reader inside a vehicle, where the reader observes the user's device using Near Field Communication (NFC).

The system 100 sensor information may help advise users of how to optimize their journey. For instance, a train station platform may not be completely level. One end of a platform may be higher than another and the end that is higher may have an elevator. Based on information from content providers, the system 100 may determine that the first car of a train will be closer to the higher side of the platform, which has the elevator. If a user is to exit at that platform, the system 100 may direct a user to the first car of the train in order to be closer to the elevator.

In one embodiment, the system 100 may also collect backend user information to validate information from content providers or independently develop an understanding of a transport means. For instance, the understanding of a transport means may include forming a collection of information regarding a train network, including information on train connections, what train lines are housed at each train station, scheduled repair work, train station configurations, timing of trains entering various platforms, orders of stations down a rail line, etc. In one embodiment, the collection of data may replace or be supplemented by manual reporting received from users. For example, if information from the system 100 is inaccurate, users may elect to notify the system 100 of the error. For instance, system 100 may be sending recommendations reflecting a blue line arriving at the left side of a platform. However, today, the blue line arrives at the right side of the platform due to repairs being conducted on the left side of the platform. Then, a user may notify system 100 that all blue lines today will be at the right side of the platform. Alternately or in addition, the system 100 may observe that all blue line users at this platform are consistently at the right side of the platform. Then, system 100 may, itself, conclude that blue line trains must only be operating from the right side of the platform. Then, subsequent recommendations from the system 100 may reflect this correction. Another instance may include noting that a particular elevator known to system 100 has no user interaction associated with it on a particular day. The system 100 may then conclude that the elevator is broken and adjust recommendations to direct users to other elevators. In one embodiment, backend user information may further inform users of the level of crowding on a train. For example, the system 100 may compare the amount of backend information received for a particular transport means relative to the maximum capacity of the transport means, as provided by content providers.

In another example, each device could share sensor information with system 100. For example, system 100 may detect simultaneous movement of multiple sensors to a certain direction. Multiple sensors having comparable readings may further reinforce and improve the reliability of detection and identification functions in system 100. For instance, the system 100 may interpret acceleration sensors for a “device A” detecting movement of device A could indicate that device A is moving with the movement of a train. If multiple devices receive acceleration sensor readings showing movement similar to train movement at the same time as that device A's acceleration sensors indicate movement train movement, system 100 could conclude with more certainty that device A is, indeed, moving within a train. If device A's “train movement” does not coincide with similar data from other devices, system 100 may conclude, for instance, that few users are in the train at this time, or that there is some error in the conclusion for device A. Similarly with the altitude sensors, more than one device having the same altitude readings may reinforce and validate system 100's inferences as to whether a device is moving up or down in an elevator based on altitude readings. In one scenario, such sharing of sensor information from multiple devices with system 100 could be conducted via an application communicating with the devices.

In one embodiment, the backend information may further be supplemented by user history information. For example, a user may commonly travel a particular route as part of his daily work commute. Then, the user may receive a notification if the user's route today deviates from his usual route, based on the sensor readings. In this way, the system 100 may provide a notification information a user of an error in his commute.

In one embodiment, the system 100 may provide various notifications and/or recommendations to facilitate a commute. In one embodiment, the system 100 may determine a user's progress in his journey based on knowing his destination and location based on the sensor readings and scheduling information (either from content providers, backend information, or a combination thereof). Based on the progress, the system 100 may, for instance, provide a user with a notification that he should exit a train at the next stop.

In yet another embodiment, the system 100 may prompt a user to choose his location. For example, where system 100 detects that a user has boarded a mean of transportation at a given station but cannot decipher which line a user is on, the system 100 may prompt a user to choose among the most relevant entries. For instance, the system 100 may present a user with a selection of lines that most closely reflects a train line that a user might be riding. Such a situation is especially likely where several train lines are at the same station and timing does not match a particular schedule, or where timings are very close. For instance, several train lines may travel along the same track for a section of the track. The system 100 may use the user selection to achieve greater accuracy in helping a user plan his route and time possible transfers in his route. For example, the user selection may help the system 100 better gauge the user's estimated time of arrival (ETA), either at the user's final destination or for train transfers.

In one embodiment, the system 100 may also facilitate sharing a user's progress along a transport means and/or destination with other users. For example, friends meeting up may benefit from knowing if one member of the group has transferred trains and will be arriving shortly to the meet-up, or if a member of the group will be very late since a particular train is running irregularly. In addition, system 100's sharing of progress along a transport means may allow people to meet at platforms and/or adjust meeting locations depending on respective positions of the people meeting.

As shown in FIG. 1, the system 100 comprises a user equipment (UE) 101a-101n (or UEs 101) having connectivity to user interface modules 103a-103n (or user interface modules 103), content providers 107a-107k (or content providers 107), a sensor platform 109, a transport platform 111, and an application 113 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the user interface module 103 may provide information regarding actions in conjunction with the UEs 101. For example, actions may include notifying the communication network 105 of a change in position of the UE 101, especially when a UE 101 enters or exits a transport means. Furthermore, the user interface module 103 may include generating notifications and/or recommendations to a user to facilitate a user's commute. For instance, the user interface module 103 may display arrival times of trains at stations relevant to a user for the user's current route. For example, after determining that a user has entered a train, the user interface module 103 may interact with the communication network 105 to display information regarding train arrival times at stations along a user's current train route. That way, if a user may strategize what station or stop to exit at, in order to transfer trains and arrive at his destination more efficiently or most quickly. In one embodiment, the user interface modules 103 may further inform the content providers 107 as to whether content provider information is accurate. For example, the user interface modules 103 may determine user behavior while in action. The sensor platform 109 and transport platform 111 may then compare user behavior information from the user interface modules 103 with information from the content providers 107 to verify or update information from the content providers 107.

In one embodiment, content providers 107 may provide expected values, with which information from user interface modules 103 is compared. For example, content providers 107 may provide scheduling information. Scheduling information may include timetables and station information, for instance, schedules of when trains, buses, trams, and/or trolleys are due at various platforms or stations along the train, bus, tram, and/or trolley routes. In other words, scheduling information may include associations between time, a location (for a platform or station), and a certain route associated with a transport means. For example, a “blue route” train may run through a set of 20 stops from the east side of a city to the west side of a city, where there is about 5 minutes between each stop and trains are 10 minutes apart during peak hours. Then, scheduling information may include each stop for a blue route train and the times at which a blue route train is expected at each stop. Scheduling information may further include adjustments for delays, repairs, or detours. For example, sometimes delays entail transferring riders on transport means, from the transport means, to a destination via an alternate transport means. For instance, weekend track work may cause the transport service to stop running trains along a certain length of track, and transport riders via bus. The scheduling information may include such information, along with adjusted times that take into account the deviations from expected schedules.

Content providers 107 may further provide expected values. For example, content providers 107 may provide locations of stations and platforms and expected sensor values associated with these stations and platforms. For instance, a station may have multiple platforms at various levels within the station. Content providers 107 may then provide the geographic location of the station, along with altitude readings that reflect the levels of the various platforms. Based on the altitude readings, the system 100 may then infer a platform at which a user may be standing in comparing a user device's altitude reading with the altitude readings from the content providers 107.

In one embodiment, the sensor platform 109 may determine whether a user has boarded a transport means. For example, the sensor platform 109 may employ the various sensors and monitor the sensors. In one embodiment, the sensor platform 109 especially notes changes in readings from the sensors and processes the changes to determine whether the changes indicate that a user has entered or exited the transport means.

In one embodiment, the transport platform 111 may determine a user's progress along a route. For example, out of ten stops that a user must travel to arrive at his destination, the transport platform 111 may determine that the user has traveled three of the ten stops and that he has seven stops left before arriving. The transport platform 111 may further revise information regarding train schedules, arrival times, and transfer information based on a user's progress along his route.

In one embodiment, the application 113 may serve as the means by which the UEs 101 and content providers 107 interact, with guidance from the sensor platform 109 and the transport platform 111. For example, the application 113 may activate upon user request or upon detection that satellite-based location sensors are unavailable. For example, application 113 may offer recommendations for transfer stations and rely on satellite-based location sensors until those sensors are unavailable. At this point, application 113 may employ the alternative means of using sensors including magnetometers, altitude sensors, and acceleration sensors to deduce information that satellite-based location sensors may offer.

By way of example, the UE 101, user interface modules 103, content providers 107, sensor platform 109, transport platform 111, and application 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

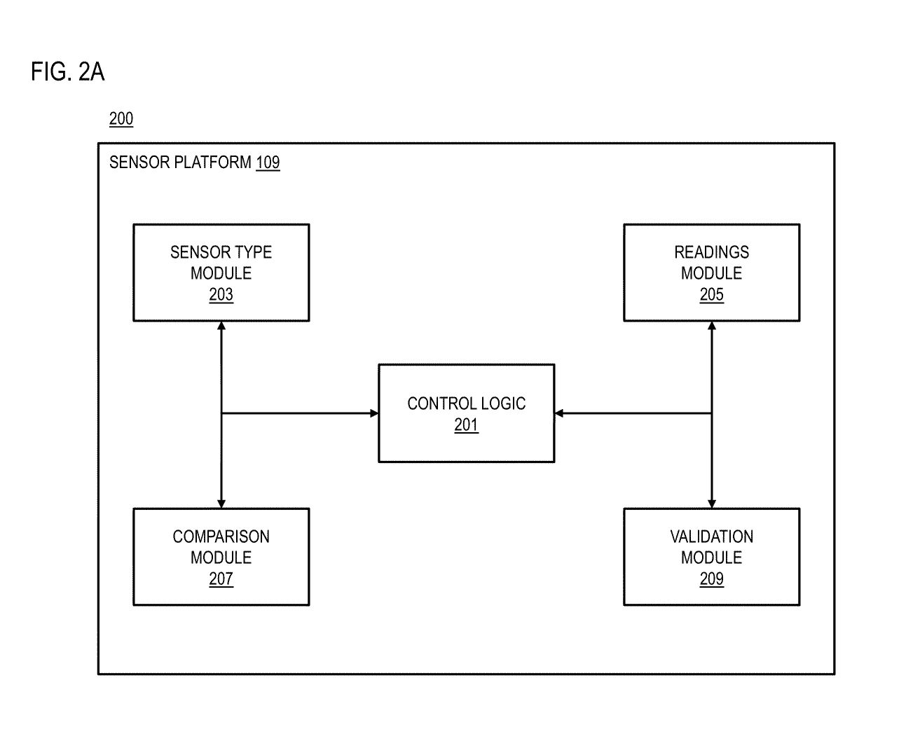

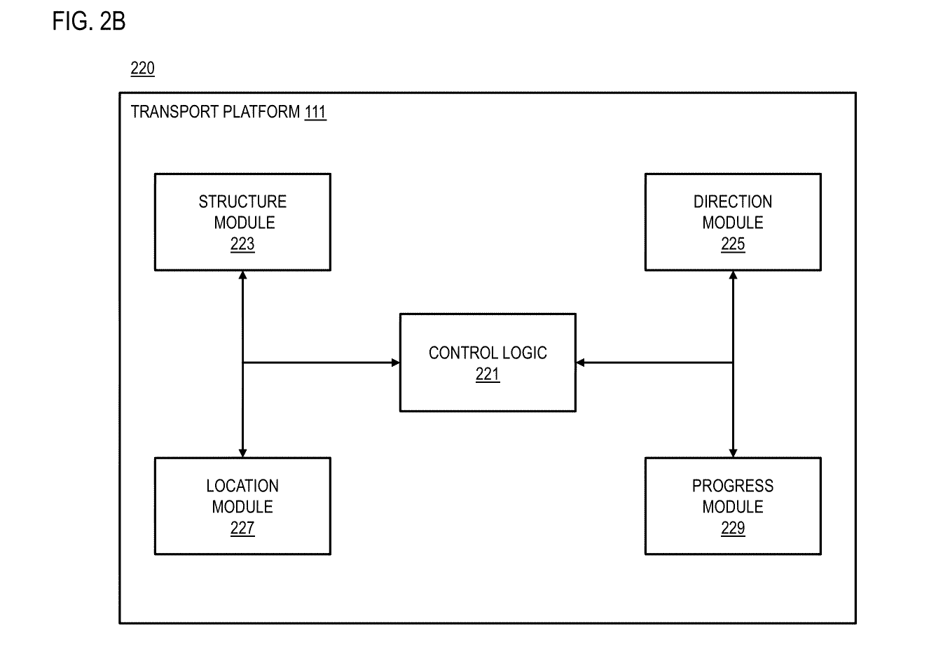

FIG. 2A is a diagram of the components of the sensor platform 109, according to one embodiment. By way of example, the sensor platform 109 includes one or more components for detecting when a user has boarded a means of transport. It is contemplated that the functions of these components may be combined in one or more components or performed by other components of equivalent functionality. In this embodiment, the sensor platform 109 includes a control logic 201, a sensor type module 203, a readings module 205, a comparison module 207, and a validation module 209.

In one embodiment, the control logic 201 and sensor type module 203 may detect and identify various sensors associated with the UEs 101. For example, UEs 101 are often readily equipped with location sensors and other sensors that may provide contextual information regarding respective Us 101, including sensors observing acceleration, tilt, altitude, temperature, magnetic fields, etc. In one embodiment, the control logic 201 and sensor type module 203 may determine the various sensors available to the system 100 through UEs 101 and group the sensors by type. For instance, the control logic 201 and sensor type module 203 may distinguish between satellite-based sensors and non-satellite-based sensors. In one embodiment, the control logic 201 and sensor type module 203 may further determine the availability of sensor readings from the detected sensors. For example, the control logic 201 and sensor type module 203 may determine that satellite-based sensors associated with UEs 101 do exist within the system 100, but they are unavailable at a given point in time.

In one embodiment, the control logic 201 and readings module 205 may monitor various sensors to determine sensor readings. In one embodiment, the control logic 201 and readings module 205 may further focus particularly on sudden and/or drastic changes in sensor readings. For example, the control logic 201 may infer that changes in sensor readings may stem from the entry or exist of a user from a transport means, as shown by a device associated with the user.

In one embodiment, the control logic 201 and comparison module 207 may compare the readings from the control logic 201 and readings module 205 to known or expected sensor readings. For example, the control logic 201 and comparison module 207 may determine whether readings coincide with the possibility that a user has entered or exited a transport means. For example, magnetometer readings may show a large increase in the presence of metals proximate a user. The control logic 201 and comparison module 207 may then deduce from this information, that a user has entered a transport means. If a magnetometer reading shows a sudden decrease in the metals proximate a user, the control logic 201 and comparison module 207 may conclude that a user might have exited a transport means. The control logic 201 and comparison module 207 may also compare readings to try to decipher which structure or supporting structure is proximate a device. In one such embodiment, the control logic 201 and comparison module 207 may determine the altitudes of various platforms within a station. For instance, platforms within a station may be at different levels below ground level. For example, platform 1 in a station, may be two floors below ground level, whereas platform 2 may be one floor below ground level. Altitude readings may then distinguish between platform 1 and 2 within this train station. In one embodiment, the control logic 201 and comparison module 207 may then determine the altitude when a user is entering a train (as determined by the magnetometer), and then infer the platform (and/or train line associated with the platform) based on the altitude.

In one embodiment, the control logic 201 and comparison module 207 may interact with user interface modules 103 of UEs 101 to cause notifications based on the comparisons. For example, once the control logic 201 determines that a user has entered a train, the control logic 201 may work with the user interface module 103 to generate a list of train arrival times for upcoming stations. For instance, the control logic 201 may receive a desired destination of a user. Based on the destination, the control logic 201 may determine possible routes available from the transport means to convey a user from his starting point, to the destination. Then, the control logic 201 may generate notifications that offer the user with possible train transfer options or recommendations so the user may time his transfers to arrive at his destination with the smoothest commute. In one embodiment, the notifications may be set according to users' preferences or priorities. For instance, a user may prioritize speed over ease. In this case, the control logic 201 may recommend a route that may be faster but involve multiple transfers. Another user may prioritize low hassle relative to speed. In such a case, the control logic 201 may recommend a route that may have fewer transfers, though it may take longer. These priorities may also be adjusted per trip. A user that generally prefers low hassle over speed may one day decide to set speed as a higher priority if she is heading to an important meeting where being punctual is imperative. Ideally, the recommendations and notifications generated by control logic 201 lend greater predictability and control over a commute.

In one embodiment, the control logic 201 and the validation module 209 may determine whether readings from the comparison module 207 are accurate. For example, the control logic 201 and validation module 209 may aggregate readings from users. For instance, a blue line train may generally arrive at platform 1 of station “X”, so the content providers 107 have blue line trains associated with platform 1 of station X. However, station X may one day be performing repairs at platform 1 and instead, route blue line trains to platform 2. In one embodiment, the control logic 201 would receive this re-routing of the blue line trains, from the content providers 107. Alternately or in addition, the control logic 201 and validation module 209 may observe from multiple user devices, that blue line trains appear to be at platform 2. Then, the control logic 201 and validation module 209 may update the association of blue line trains with platform 1, to associate blue line trains with platform 2. If sensor readings appear to again start showing blue line trains at platform 1 rather than platform 2, the control logic 201 and validation module 209 may again update the association to revise blue line trains at station X to be associated with platform 1.

In one embodiment, the control logic 201 and validation module 209 may discover discrepancies between expected readings and/or scheduling information provided by content providers 107 by aggregating user data. For example, the control logic 201 and readings module 205 may already receive, monitor, and/or follow sensor readings read by multiple devices. The control logic 201 may also receive information on destinations and whether users backtrack along a certain direction in a train. For instance, if a user switches trains, rides one stop, then switches directions (presumably because of some error in switching trains), control logic 201 may note this behavior as backtracking. The control logic 201 may process this information including sensor readings, destinations, and errors such that the control logic 201 and validation module 209 may continually ensure that the information that the comparison module 207 is using to compare sensor readings to, is accurate. For example, the control logic 201 and validation module 209 may aggregate information collected from multiple users and evaluate the information to determine whether the information reflects information given by the content providers 107. In addition, the control logic 201 and validation module 209 may flag warning signs of possible inaccuracies where users appear to retrace their steps, for example, riding one stop eastward that leaves from station X, exiting the train, crossing to another platform, and then riding back to station X traveling westward. Such backtracking may be indication that trains are not running from platforms as indicated by information from content providers 107, in which case, the control logic 201 and validation module 209 may provide an updated version of schedules and/or platforms relative to trains.

FIG. 2B is a diagram of the components of the transport platform 111, according to one embodiment. By way of example, the transport platform 111 includes one or more components for providing information regarding the progress of a user along the transport means. It is contemplated that the functions of these components may be combined in one or more components or performed by other components of equivalent functionality. In this embodiment, the transport platform 111 includes a control logic 221, a structure module 223, a direction module 225, a location module 227, and a progress module 229.

In one embodiment, the control logic 221 and the structure module 223 may determine structures and supporting structures associated with transport means. For example, a transport means comprised of an underground rail system may include structures, for example, trains or individual rail cars that make up the trains. Supporting structures associated with these trains may include train platforms, buildings or landmarks near train stations and/or platforms, etc. Often train stations are near bus stops. In this case, structures may include buses, with supporting structures including, for example, bus stops. In another scenario, the control logic 221 may define the structures and supporting structures where structures include rail cars and supporting structures are associated platforms, train stations, buses, and bus stops (so that buses and bus stops are defined as supporting structures relative to the rail car structures). In one embodiment, the control logic 221 and structure module 223 may also determine the locations of these structures and supporting structures. For example, the control logic 221 and structure module 223 may essentially map out locations of supporting structures. For instance for an underground rail system, the control logic 221 and structure module 223 may determine all the stations associated with the rail system. The control logic 221 and structure module 223 may further determine each of the platforms within each of the stations and all of the station entrances within a rail system.

In one embodiment, the control logic 221 and the direction module 225 may determine the direction of movement of at least one structure relative to at least one supporting structure. For example, the control logic 221 and direction module 225 may determine acceleration sensor readings from the sensor platform 109 and determine the direction of movement. In another embodiment, the control logic 221 and direction module 225 may also determine the direction based on information provided by content providers 107. For example, content providers 107 may know what side of the platform a train is expected to arrive at, given its direction. For example, a train pulling into station X traveling east may have passengers boarding and exiting on the left side of the train. However, as the train pulls in the next station, station Y, the platform may be on the right side of the train. This scenario may further be characterized where a train traveling west would have passengers exiting on the right side at station X and on the right side of station Z, the station following station X for a westbound train. By observing that this train has a platform, first, on its left side and then on its right side, the control logic 221 and the direction module 225 may determine that the train is eastbound. By finding that the train is eastbound, the control logic 221 and direction module 225 may help to identify the train line, as well as the location of the train. For instance, if control logic 221 (or control logic 201) may determine that a user is inside a train based on magnetometer readings. Then, the control logic 221 may determine the direction of the blue line train to determine a train's location, especially where satellite-based location sensors are unavailable.

In one embodiment, the control logic 221 and location module 227 may determine location of at least one device by accessing scheduling information from the content providers 107. The scheduling information may include orders of train stations. For instance, an eastbound blue line train may head to station Y after stopping at station X while a westbound blue line train may head to station W at the next stop. Therefore, based on the direction, the control logic 221 and location module 227 may determine that a user on an eastbound blue line train leaving station X, will be at station Y when the trains stops again. A passenger on the westbound blue line train, however, should be at station W when his train stops again. Therefore, the control logic 221 and location module 227 may provide an alternative means of determining location when satellite-based location sensors are unavailable. In finding the location, the control logic 221 and location module 227 may not need to know the precise geographical location of a user or his device. Rather, the control logic 221 and location module 227 may simply determine where a user is, along the series of train stations at which a train is due to stop. In one embodiment, the control logic 221 and location module 227 may then offer predictions or recommendations. For example, the control logic 221 and location module 227 may inform recommendations as to when a user should transfer lines to arrive at his destination most quickly, or if a user should take a longer route since transferring trains would total to even more time since the user would have to wait a long time for the next train.

In one embodiment, the control logic 221 and location module 227 may include detailed location information. Detailed location information may include, for example, station configurations, for instance, where elevators or transfers are located within a train station. For example, the control logic 221 and location module 227 may determine that a user appears to be in the fourth car of an eight-car train. However, elevators within a train station may be located at the far ends of a platform. Where a user has to make a quick transfer to run to a platform on another level within the train station, the control logic 221 and location module 227 may prompt a notification for the user to move from the middle of the eight-car train, to the ends of the eight-car train in order to reach his transfer platform sooner. In one embodiment, the control logic 221 and location module 227 may receive this information from the content providers 107, where the content providers 107 may, for example, keep a collection of information about each station along a train network.

In one embodiment, the control logic 221 and progress module 229 may set the location of a user and/or his device, in the context of the progress of the user along his transport means or journey. For example, a user's journey may entail traveling seven stops on a blue line train. The control logic 221 and progress module 229 may determine how many stops a user may have remaining, before arriving at his destination. In addition, the control logic 221 and progress module 229 may calculate any possibilities for alternate routes in the context of a transport means network. For instance, rather than traveling seven stops on a blue line train, a user may switch to a green line train that would provide a faster commute. The blue line train may intersect with the green line train at the third of the seven stops. In this case, the control logic 221 and progress module 229 may determine the timing of the next green line train and calculate whether it is worthwhile for the user to switch to the green line, taking account the timing of the next green line train, or if staying on the blue line train would, in fact, be comparable. The control logic 221 and progress module 229 may adjust such calculations while understanding where a user is, for instance with respect to the rail lines, along his journey to his destination.

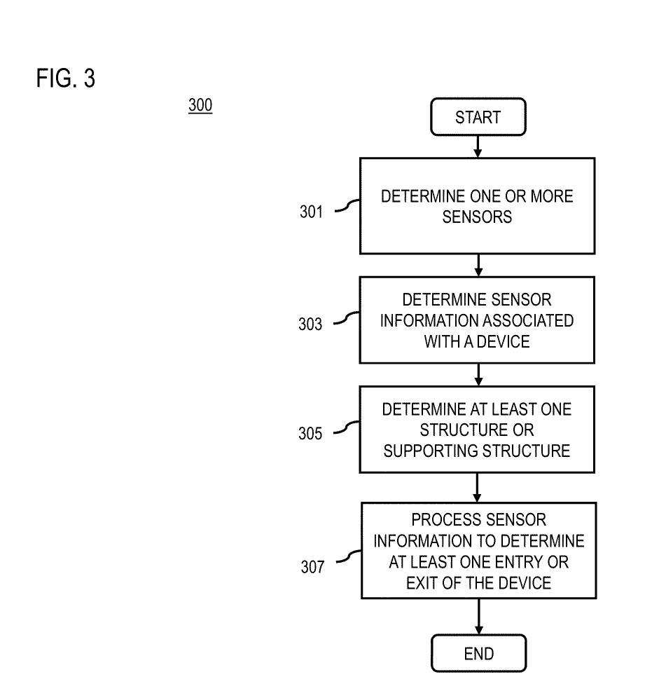

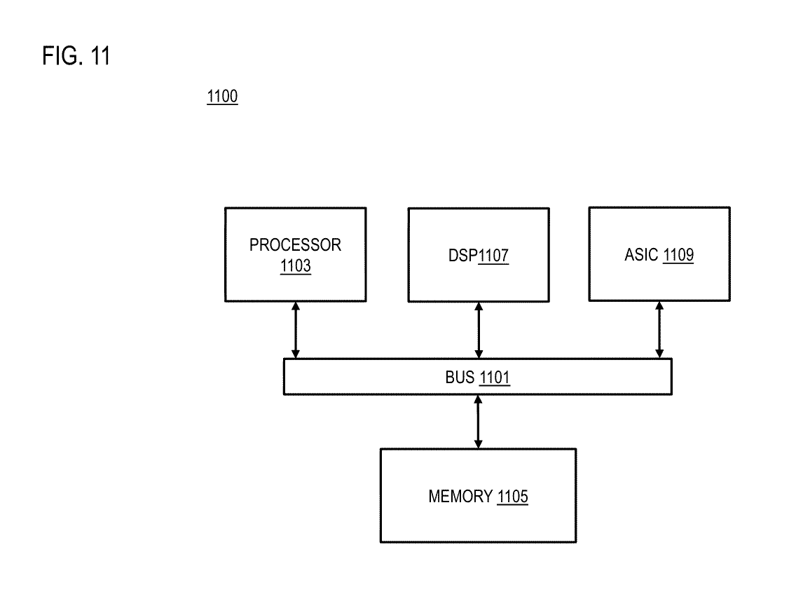

FIG. 3 is a flowchart of a process for detecting when a user has boarded a means of transport, according to one embodiment. In one embodiment, the control logic 201 performs the process 300 and is implemented in, for instance, a chip set including a processor and a memory as shown in FIG. 11. In step 301, the control logic 201 may determine one or more sensors, specifically sensors that include or do not include satellite-based location sensors. Then in step 303, the control logic 201 may determine sensor information associated with at least one device, wherein the sensor information is collected from one or more sensors, wherein the sensor information includes sensory information. In one embodiment, the control logic 201 may receive sensor information wherein the sensor information includes, at least in part, magnetometer sensor information, altitude sensor information, acceleration sensor information, or a combination thereof. For step 305, the control logic 201 may determine at least one structure or at least one supporting structure associated with one or more transport means. In one embodiment, the supporting structure may be associated with the at least one structure. For step 307, the control logic 201 may process and/or facilitate a processing of the sensor information to determine at least one entry or at least one exit of the at least one device with respect to at least one structure, at least one supporting structure associated with the at least one structure, or a combination thereof associated with one or more transport means. Then, step 307 may include a method further comprising determining the entry or the exit of at least one device based, at least in part, on the magnetometer sensor information. In a further embodiment, the control logic 201 may further include causing, at least in part, one or more notifications based, at least in part, on the at least one entry or at least one exit of the at least one device.

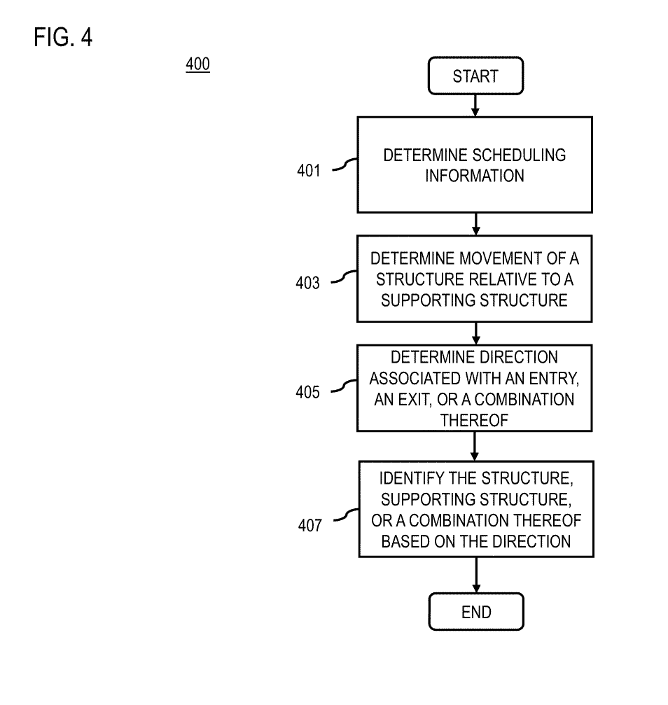

FIG. 4 is a flowchart of a process for determining the location of a user or device associated with a user relative to a transport means, according to one embodiment. In one embodiment, the control logic 221 performs the process 400 and is implemented in, for instance, a chip set including a processor and a memory as shown in FIG. 11. In step 401, the control logic 221 may determine scheduling information associated with the at least one or more transport means. For example, for step 403, the control logic 221 may determine movement of at least one structure relative to a supporting structure. Then in step 405, the control logic 221 may determine a direction associated with movement of at least one structure relative to the at least one supporting structure, wherein the identification of the at least one structure, the at least one supporting structure, or a combination thereof is based, at least in part, on the direction. Alternately for steps 405 and 407, the control logic 221 may cause, least in part, an identification of the at least one structure, the at least one supporting structure, or a combination thereof based, at least in part, on the scheduling information. In one embodiment, the structure and the supporting structure may be related wherein the at least one supporting structure is stationary relative to the at least one structure. For example, a train platform or train station may comprise a supporting structure relative to a train car structure.

In one embodiment, the control logic 221 may determine one or more changes in the sensor information and cause, at least in part, an identification, validation, or a combination thereof of the scheduling information based, at least in part, on the one or more changes. For example, sensor information may go towards a backend log that validates and/or updates information from the content providers. In one embodiment, this identification or validation may take into account manual user input. For example, users may access application 113 via user interface modules 103 to inform the system of necessary updates in scheduling information.

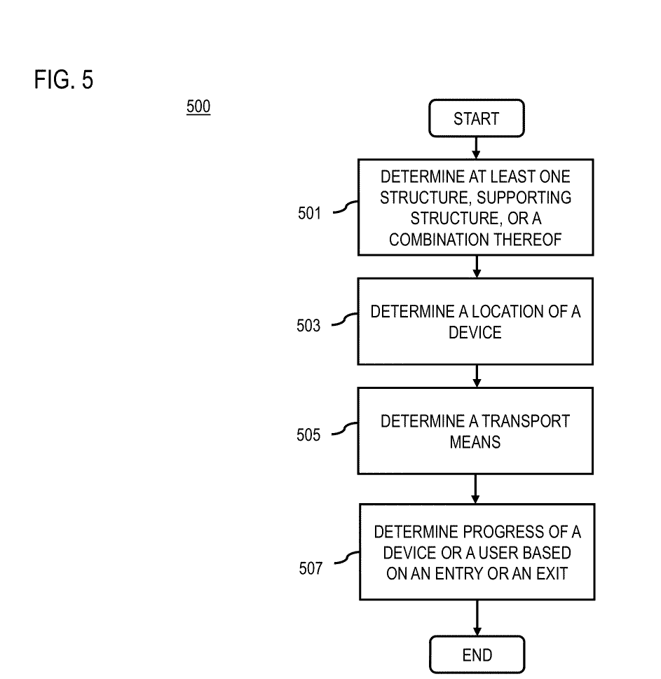

FIG. 5 is a flowchart of a process for determining the progress of a user or device associated with a user relative to a transport means, according to one embodiment. In one embodiment, the control logic 221 performs the process 500 and is implemented in, for instance, a chip set including a processor and a memory as shown in FIG. 11. As previously discussed, control logic 221 may include a method wherein the sensor location includes, at least in part, magnetometer sensor information, altitude sensor information, acceleration sensor information, or a combination thereof. For step 501, the control logic 221 may determine at least one structure, at least one supporting structure, or a combination thereof. Then for step 503, the control logic 221 may include the method further comprising processing and/or facilitating a processing of the sensor information to determine at least one location of the at least one device with respect to the at least one structure, the at least one supporting structure, or a combination hereof. In one embodiment, step 505 may include determining one or more transport means. Then for step 507, the control logic 221 may determine a progress of the at least one device along the one or more transport means based, at least in part, on the at least one entry, the at least one exit, or a combination thereof. For example, the location of a device may give the control logic 221 indication of how far a user is, in her journey. Based on such information, the control logic 221 may compile and/or update recommendations for transfers, prompt a notification advising a user to get ready to exit his transport means, offer a user an option to share his location with his friends of family, etc. For example, a user may wish to send a notification to his child's school that he is running late in picking up his child and provide an estimated time of arrival.

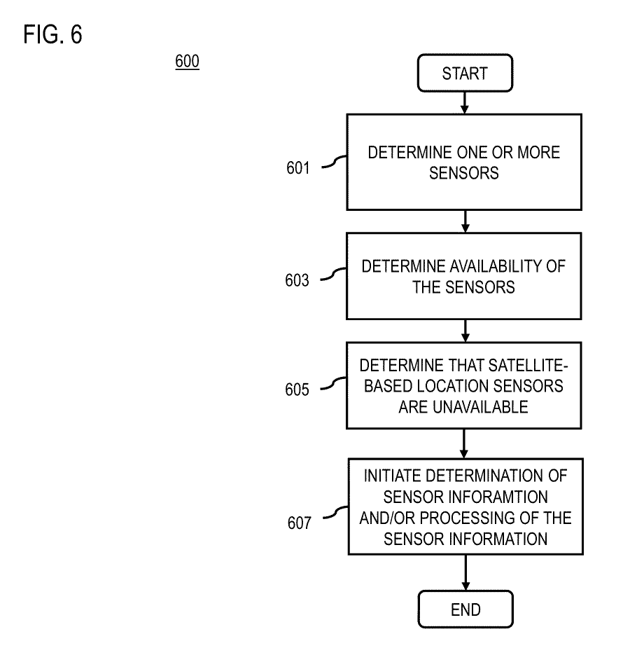

FIG. 6 is a flowchart of a process for determining whether to initiate determination of the sensor information, according to one embodiment. In one embodiment, the control logic 201 performs the process 600 and is implemented in, for instance, a chip set including a processor and a memory as shown in FIG. 11. In one embodiment, the control logic 201 may determine one or more sensors and the availability of the sensors (step 601 and step 603). Then with step 605, the control logic 201 may determine that satellite-based location sensors are unavailable. For step 607, the control logic 201 may cause, at least in part, an initiation of the determination of the sensor information, the processing of the sensor information, or a combination thereof based, at least in part, on at least one determination that one or more non-sensory sensors are unavailable.

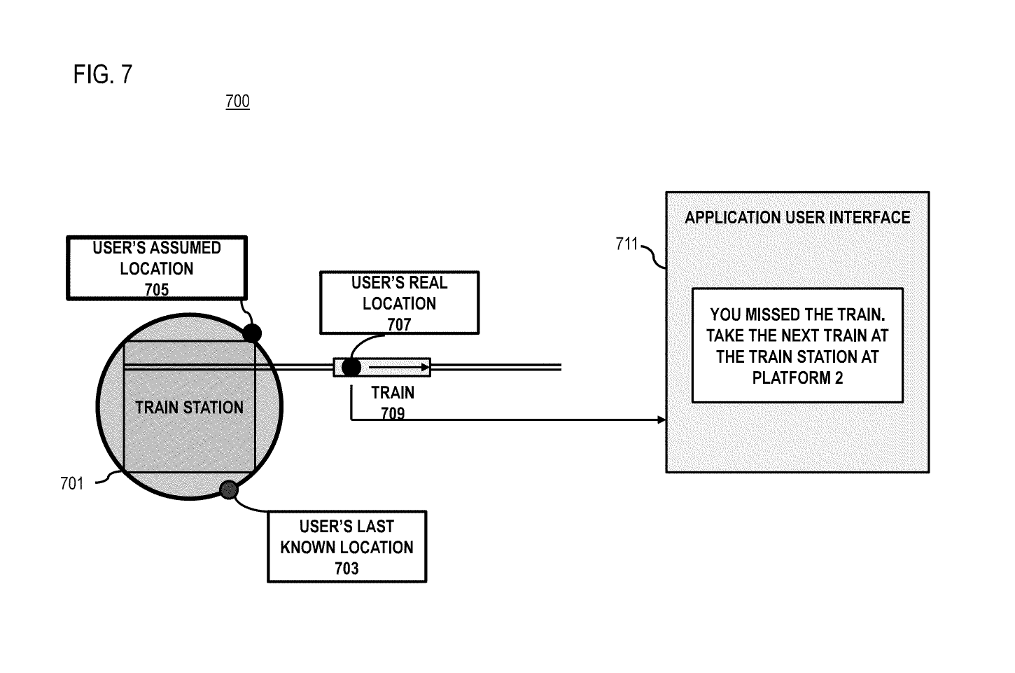

FIG. 7 is a diagram of a use case 700, in one embodiment. In one embodiment, a user may be at a train station 701, where the user's last known location 703 is proximate the user train station 701 or the exterior of the train station 701. In other words, the user's last known location 703 may act as the user's assumed location 705. Alternately, the user's last known location 703 may be equated to the location of the train station 701. The last known location 703 (and by extension, assumed location 705) may be based on readings from, for example, satellite-based location sensors. In one embodiment, a user's real location 707 may, in fact, be inside a train 709 traveling in the train station 701. However, satellite-based location sensors are often unavailable inside underground train stations, which may include train station 701. Therefore, the user interface notification 711 may not account for the user boarding the train 709 and having a real location 707 that is equivalent to train 709. In not realizing that the user has boarded train 709, the user interface notification 711 may display a message reflecting the user as being at the user's last known location 703 and/or the user's assumed position 705, so the message may tell the user that the train 709 has left and the user must wait for another train. The user interface notification 711 may not update to realize that the user's real location 707 is the location of train 709, rather than the last known location 703 or assumed position 705.

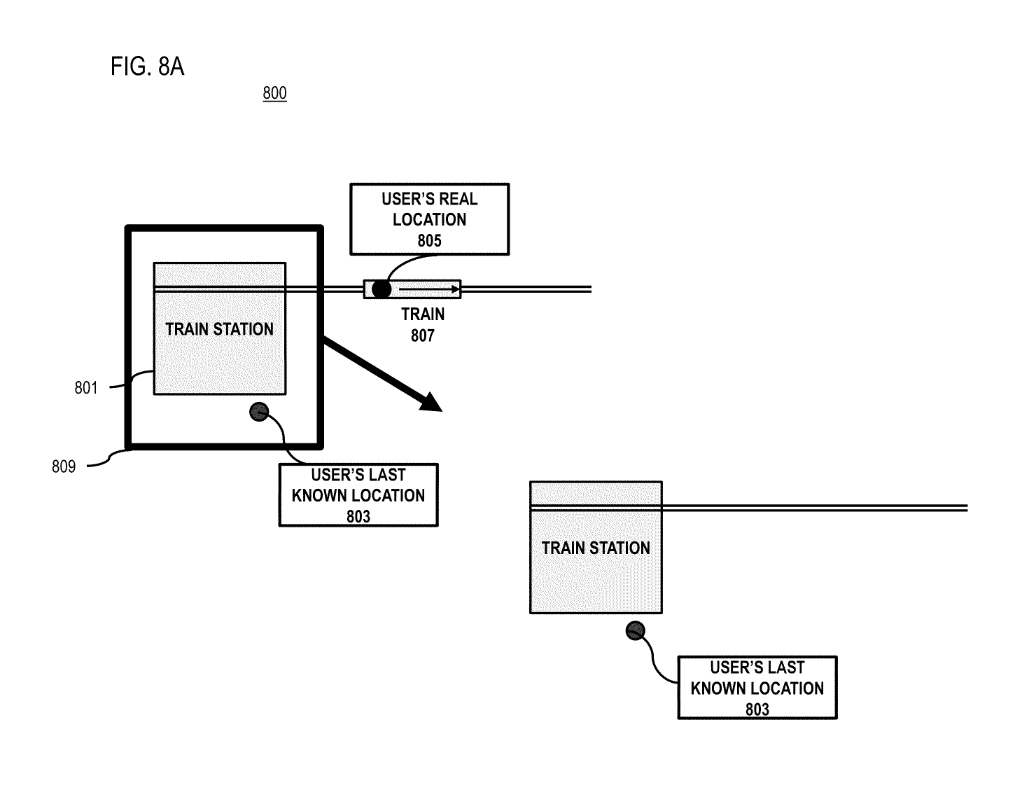

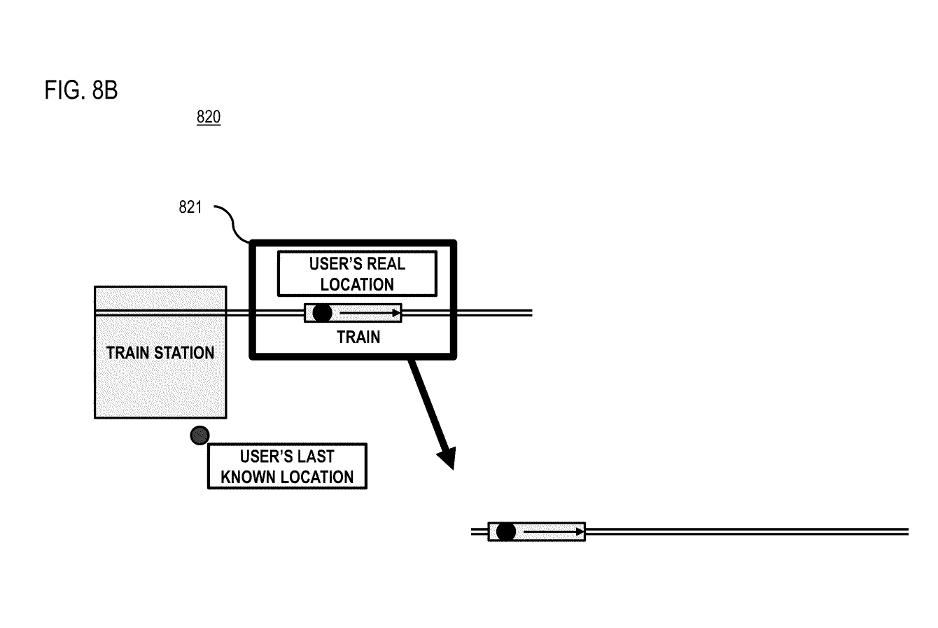

FIGS. 8A and 8B are diagrams of two phases of a use case with system 100, in one embodiment. As shown in the first phase 800 and second phase 820, the system 100 may determine a train station 801, along with a user's last known location 803 (as possibly provided by satellite-based location sensors). In one embodiment, first phase 800 may determine that a user has entered a train. As previously discussed, the user's real location 805 may differ from the user's last known location 803. In fact, the user's real location 805 may be the location of train 807. In the first phase 800, system 100 may employ altitude sensors and related sensors to determine the platform at which a user boards the train 807. Information on altitudes of various platforms in a train station may come from content providers 107. System 100 may also use magnetometer sensors to determine when a user is inside a train, when use acceleration sensors to detect movement and direction of movement. In one embodiment, system 10 may use train schedules (from, for example, content providers), along with the acceleration and magnetometer sensor information, to detect which train a user has boarded. For first phase 800, the system 100 last determines that a user has entered a train station, as indicated by square 809, as the user's location as seen by the system 100.

FIG. 8B shows the second phase 820, where the system 100 may determine that a user has exited a train, in one embodiment. Here, the system 100 may use altitude sensors and magnetometer sensors to determine when a user leaves the train, as shown by the user position mark 821. For example, magnetometer sensors may show a sudden change in readings. The system 100 may take this change to mean a difference in a user's surroundings. If a magnetometer sensor change is paired with an altitude change, system 100 may infer that a user has exited a train. For example, passengers on underground trains often change altitude to come above ground after exiting trains. In one embodiment, the system 100 may also compare altitude readings with train schedule and train station information, since trains sometimes also change altitude along their journey, where tracks are underground in some parts, and above ground in others. In one embodiment, the system 100 may further user acceleration sensors to detect when a train stops movement and detect the direction of movement. In this case, acceleration sensors may inform when a user exits a train, but also where a train might be along its journey, even if a user does not exit.

In repeating the two phases of detecting boarding and exiting the train, system 100 may detect multiple train connections and users' locations. Then, system 100 may form an understanding of train schedules independently from schedules from content providers. In one embodiment, the system 100 may use this sensor-based understanding of train schedules to validate the schedules from content providers. Sometimes, deviations from schedules from content providers are temporary. Changes may happen daily or on weekends and holidays due to emergencies, accidents, and/or scheduled repairs. At other times, deviations may entail a more permanent update to the content provider schedules. In one embodiment, system 100 may employ the sensor-based understanding of train schedules in place of content provider train schedules where the sample size and input is large enough and consistent enough to provide a reliable understanding.

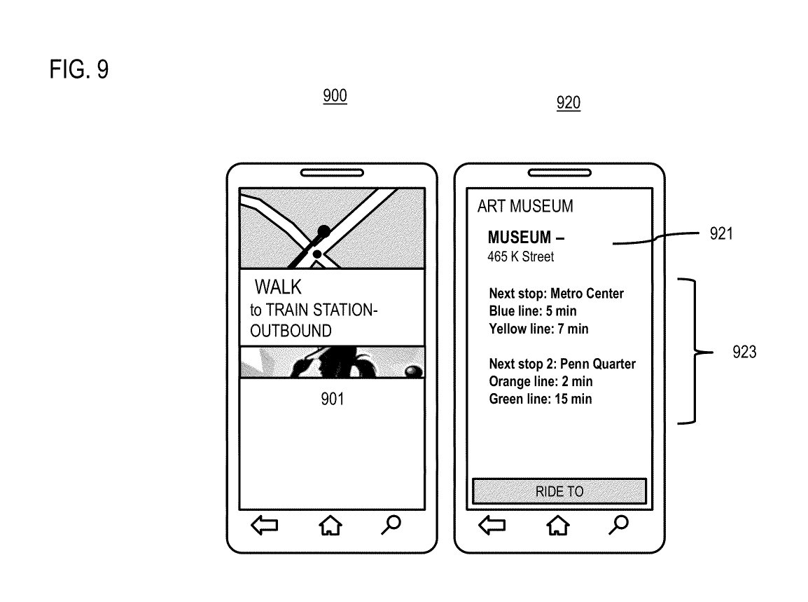

FIG. 9 is a diagram of user interfaces utilized in the processes of FIG. 3, according to various embodiments. For diagram 900, the user interface may first have a navigation screen 901 directing a user to a train station. This diagram 900 may display while satellite-based location sensors are available. When system 100 detects that satellite-based location sensors are unavailable, the system 100 may initiate displays similar to diagram 920. Diagram 920 may appear once system 100 detects that a user has boarded a train. In one embodiment, diagram 920 may include a destination 921. Based on the destination 921 and the train that a user is riding, diagram 920 may show upcoming stops, as well as arrival times of possible transfer trains to arrive at the destination 921. In one embodiment, the diagram 920 may display the possible transfers as a listing 923, including upcoming stops in the order that a user will arrive at, along with arrival times of possible transfers. The diagram 920 may account for the train that a user has boarded in showing the listing. In one embodiment, the listing 923 may further include similar information for projected times, assuming a user takes a transfer. For instance, the listing 923 would then give a user an idea of his arrival time should he transfer more than once. In another embodiment, the diagram 920 may include the times as projected on top of a map, for instance, a map of an underground rail network so a user may better visualize her journey. This map could be in place of the listing 923, an alternative to the listing 923, or presented such that either the map or listing appears as a hovering window or semi-transparent overlay over the other.

The processes described herein for detecting when a user has boarded a means of transport may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

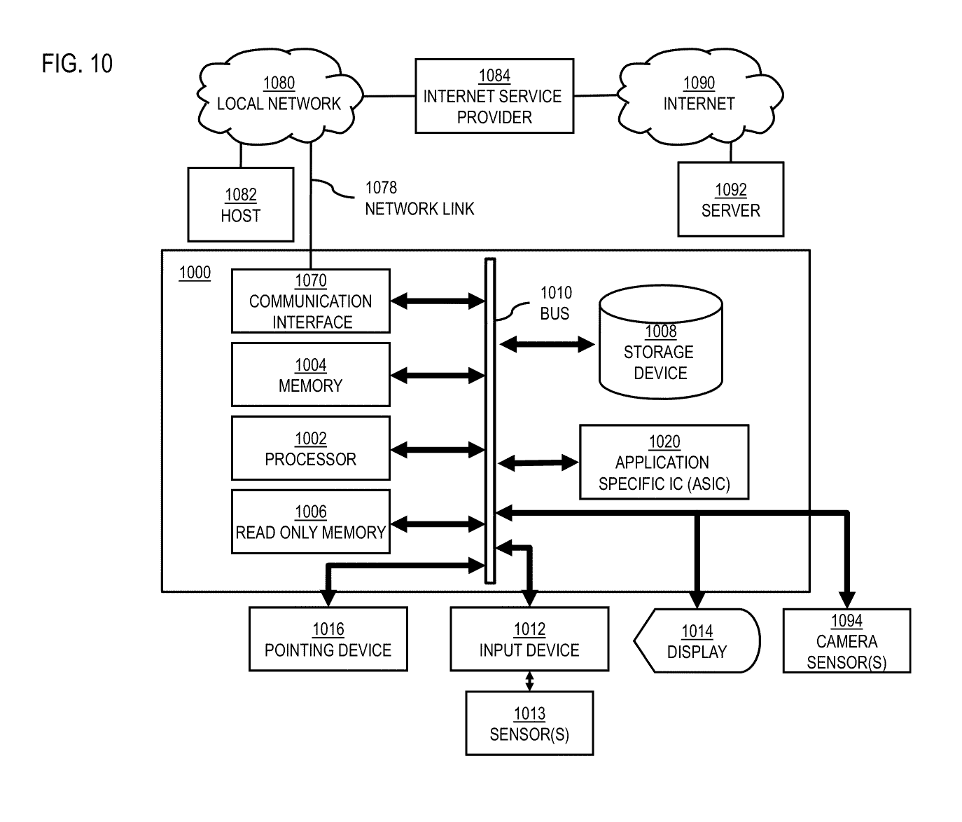

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to detect when a user has boarded a means of transport as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of detecting when a user has boarded a means of transport.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to detect when a user has boarded a means of transport. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for detecting when a user has boarded a means of transport. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for detecting when a user has boarded a means of transport, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for detecting when a user has boarded a means of transport to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to detect when a user has boarded a means of transport as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of detecting when a user has boarded a means of transport.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to detect when a user has boarded a means of transport. The memory 1105 also stores the data associated with or generated by the execution of the inventive steps.

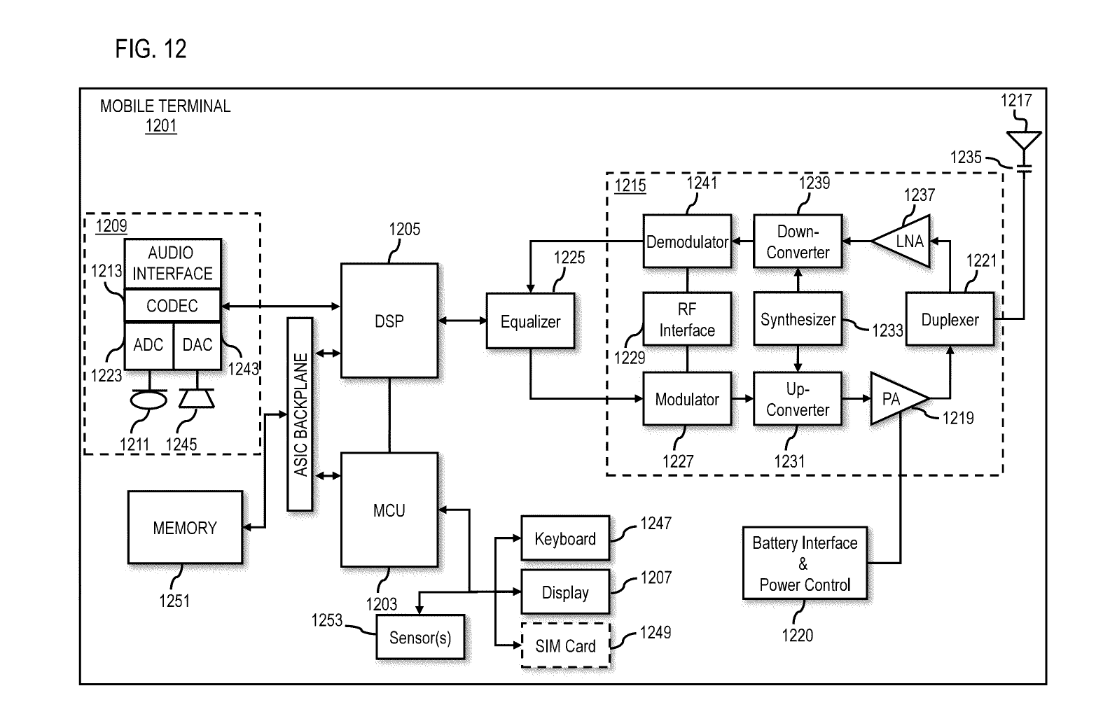

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of detecting when a user has boarded a means of transport. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of detecting when a user has boarded a means of transport. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to detect when a user has boarded a means of transport. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of sensor information associated with at least one device, wherein the sensor information is collected from one or more sensors, wherein the sensor information includes sensory information; and
a processing of the sensor information to determine at least one entry or at least one exit of the at least one device with respect to at least one structure, at least one supporting structure associated with the at least one structure, or a combination thereof associated with one or more transport means.

2. A method of claim 1, wherein the (1) data and/or (2) information and/or (3) at least one signal are further based, at least in part, on the following:
at least one determination of a progress of the at least one device along the one or more transport means based, at least in part, on the at least one entry, the at least one exit, or a combination thereof.

3. A method of claim 1, wherein the (1) data and/or (2) information and/or (3) at least one signal are further based, at least in part, on the following:
at least one determination of scheduling information associated with the at least one or more transport means; and
an identification of the at least one structure, the at least one supporting structure, or a combination thereof based, at least in part, on the scheduling information.

4. A method of claim 3, wherein the (1) data and/or (2) information and/or (3) at least one signal are further based, at least in part, on the following:
at least one determination of a direction associated with movement of the at least one structure relative to the at least one supporting structure,
wherein the identification of the at least one structure, the at least one supporting structure, or a combination thereof is based, at least in part, on the direction.

5. A method of claim 3, wherein the (1) data and/or (2) information and/or (3) at least one signal are further based, at least in part, on the following:
at least one determination of one or more changes in the sensor information; and
an identification, validation, or a combination thereof of the scheduling information based, at least in part, on the one or more changes.

6. A method of claim 1, wherein the sensor information includes, at least in part, magnetometer sensor information, the method further comprising:
a processing of the sensor information to determine the at least one entry or the at least one exit of the at least one device based, at least in part, on the magnetometer sensor information.

7. A method of claim 1, wherein the sensor information includes, at least in part, magnetometer sensor information, altitude sensor information, acceleration sensor information, or a combination thereof, the method further comprising:
a processing of the sensor information to determine at least one location of the at least one device with respect to the at least one structure, the at least one supporting structure, or a combination thereof.

8. A method of claim 1, wherein the (1) data and/or (2) information and/or (3) at least one signal are further based, at least in part, on the following:
an initiation of the determination of the sensor information, the processing of the sensor information, or a combination thereof based, at least in part, on at least one determination that one or more non-sensory sensors are unavailable.

9. A method of claim 1, wherein the (1) data and/or (2) information and/or (3) at least one signal are further based, at least in part, on the following:
one or more notifications based, at least in part, on the at least one entry or at least one exit of the at least one device.

10. A method of claim 1, wherein the at least one supporting structure is stationary relative to the at least one structure.

11. An apparatus comprising:
at least one processor; and
at least one memory including computer program code for one or more programs,
the at least one memory and the computer program code configured to, with the at least one processor, cause the apparatus to perform at least the following,
determine sensor information associated with at least one device, wherein the sensor information is collected from one or more sensors, wherein the sensor information includes sensory information; and
process and/or facilitate a processing of the sensor information to determine at least one entry or at least one exit of the at least one device with respect to at least one structure, at least one supporting structure associated with the at least one structure, or a combination thereof associated with one or more transport means.

12. An apparatus of claim 11, wherein the apparatus is further caused to:
determine a progress of the at least one device along the one or more transport means based, at least in part, on the at least one entry, the at least one exit, or a combination thereof.

13. An apparatus of claim 11, wherein the apparatus is further caused to:
determine scheduling information associated with the at least one or more transport means; and
cause, at least in part, an identification of the at least one structure, the at least one supporting structure, or a combination thereof based, at least in part, on the scheduling information.

14. An apparatus of claim 13, wherein the apparatus is further caused to:
determine a direction associated with movement of the at least one structure relative to the at least one supporting structure,
wherein the identification of the at least one structure, the at least one supporting structure, or a combination thereof is based, at least in part, on the direction.

15. An apparatus of claim 13, wherein the apparatus is further caused to:
determine one or more changes in the sensor information; and
cause, at least in part, an identification, validation, or a combination thereof of the scheduling information based, at least in part, on the one or more changes.

16. An apparatus of claim 11, wherein the sensor information includes, at least in part, magnetometer sensor information, wherein the apparatus is further caused to:
process and/or facilitate a processing of the sensor information to determine the at least one entry or the at least one exit of the at least one device based, at least in part, on the magnetometer sensor information.

17. An apparatus of claim 11, wherein the sensor information includes, at least in part, magnetometer sensor information, altitude sensor information, acceleration sensor information, or a combination thereof, wherein the apparatus is further caused to:
process and/or facilitate a processing of the sensor information to determine at least one location of the at least one device with respect to the at least one structure, the at least one supporting structure, or a combination thereof.

18. An apparatus of claim 11, wherein the apparatus is further caused to:
cause, at least in part, an initiation of the determination of the sensor information, the processing of the sensor information, or a combination thereof based, at least in part, on at least one determination that the one or more satellite-based location sensors are unavailable.

19. An apparatus of claim 11, wherein the apparatus is further caused to:
cause, at least in part, one or more notifications based, at least in part, on the at least one entry or at least one exit of the at least one device.

20. An apparatus of claim 11, wherein the at least one supporting structure is stationary relative to the at least one structure.

21.-48. (canceled)
